(19) United States
(12) Patent Application Publication
(10) Pub. No.: US 2016/0033009 A1
(43) Pub. Date: Feb. 4, 2016

(54) Eccentric Drive

(71) Applicant: Deere & Company, Moline, IL (US)

(72) Inventor: Monica Gil, Parla (ES)

(21) Appl. No.: 14/790,273

(22) Filed: Jul. 2, 2015

(30) Foreign Application Priority Data
Aug. 1, 2014 (DE) 102014215163.5

(51) Int. Cl. F16H 1/20; A01D 41/12; F16H 29/12

(52) U.S. Cl. CPC F16H 1/203; F16H 29/12; A01D 41/12

(57) ABSTRACT

An eccentric drive for driving cutter mechanisms on mowing attachments for combine harvesters is provided that comprises a gearbox housing (16), a gearbox chamber (12) enclosed by the gearbox housing (16), a first shaft (20) mounted in the gearbox housing (16), a cavity (88) formed in the first shaft (20) and having its cross-sectional center of gravity eccentric to the axis of rotation (18), in which cavity a second shaft (106) is rotatably mounted, having a toothed region (124), which is engaged with the gearbox housing (16), and a shaft end region (113) protruding axially from the cavity (88) of the first shaft (20), and a third shaft (26) wherein a flywheel body (152) can be connected to the third shaft (26) via a bushing (154) that is tapered on its outer surface (158) and is arranged rotatably fixedly and axially fixably on the third shaft (26).

### FIELD OF THE INVENTION

The invention relates to drives for eccentric drives.

### BACKGROUND OF THE INVENTION

Eccentric drives that have gear transmissions arranged at an angle to one another and gear shafts arranged one inside another are known in the prior art. Eccentric drives with gear shafts arranged one inside another provide a compact design and are one possibility for realizing eccentric drives. Eccentric drives are used, for example, in agriculture for driving cutter mechanisms on mowing attachments for combine harvesters. Such eccentric drives can additionally have a flywheel body on their driveshaft, which is mounted on the shaft and rotatably fixed thereon. It is common to secure this flywheel body rotatably fixedly on the driveshaft by means of a conventional feather key/groove connection and to clamp it via a shaft nut against a shaft shoulder on the driveshaft.

If there is too little clamping torque or during highly stressed operating states, the shaft nut can come loose on the shaft, threatening the loss of the flywheel body, with which irreparable damage to the eccentric drive and its environment and therefore also high repair costs and maintenance effort can arise. In order to counteract this, it was attempted to form the shaft nut and the driveshaft larger for the purpose of being able to apply a larger clamping torque, but this entails material and tool costs as well as increased maintenance effort. Another solution was to lock the flywheel body and the shaft together by a transverse pin, whereby the production and assembly expense became uneconomical.

The problem addressed by the invention is that of specifying an eccentric drive of the type mentioned above by which one or more or of the above-mentioned problems are overcome.

The problem is solved according to the invention by the teaching of Claim 1. Advantageous configurations and refinements of the invention are found in the subordinate claims.

### SUMMARY OF THE INVENTION

The invention relates to an eccentric drive, having a gearbox housing, a gearbox chamber enclosed by the gearbox housing, a first shaft mounted in the gearbox housing, a cavity formed in the first shaft and having its cross-sectional center of gravity eccentric to the axis of rotation, a second shaft rotatably mounted in the cavity of the first shaft and having at least one toothed region and one shaft end region protruding axially from the cavity of the first shaft, and a third shaft mounted in the gearbox housing, the axis of rotation of which third shaft includes an angle to the plane lying on the axis of rotation of the first shaft, wherein the third shaft accommodates a flywheel body.

According to the invention, an eccentric drive of the type mentioned above is constructed in such a manner that the flywheel body can be connected to the third shaft via a conically tapering bushing arranged rotatably fixedly and axially fixably on the third shaft, wherein the flywheel body has a conically tapering hub corresponding to the outer surface of the bushing, with which hub the flywheel body can be pressed on the outer surface of the bushing by means of a shaft nut arranged on the third shaft. Owing to this arrangement, particularly the conical formation of the bushing and the flywheel body, a much larger surface area is created on which a clamping torque can be exerted, whereby greater frictional forces can act at the connection of flywheel body and bushing, with equal or even less clamping torque. The use of a conical bushing also makes it possible to adapt already existing flywheel bodies by slight modifications, so that the eccentric drives assembled according to the conventional method can be modified or converted at low expense.

A recess for receiving a rotational driver is formed on the outer surface of the bushing and a broached groove is formed on the inner side of the hub. This measure proves to be easy to assemble and inexpensive, and therefore also offers the above-mentioned advantages.

The recess can be formed as a Woodruff key groove and the rotational driver as a Woodruff key, wherein the Woodruff key can be formed as a semicircular half-disk. This type of design is distinguished by a simple variant that is cost effective in terms of production and assembly effort.

It is possible in the same manner, however, to design the recess as a feather key groove and the rotational driver as a feather key. This may increase the production expense, but it also increases wear resistance.

A recess for receiving the rotational driver is likewise formed on the shaft and a broached groove is formed on the inner side of the bushing. The recess on the shaft is advantageously formed as a feather key groove and the rotational driver as a feather key. The above mentioned advantages result equivalently in this way.

The invention, advantages thereof and advantageous refinements and configurations of the invention will be described in detail below with reference to the drawing, which shows an embodiment of the invention.

### BRIEF DESCRIPTION OF THE DRAWINGS

FIG. 1 shows a first partial cross-sectional view of an eccentric drive having a flywheel body on a shaft of the eccentric drive.

FIG. 2 shows a second partial cross-sectional view of the eccentric drive from FIG. 1 and an enlarged detail of the arrangement for connecting the flywheel body to the shaft of the eccentric drive.

FIG. 3 shows a third partial cross-sectional view of the eccentric drive from FIGS. 1 and 2 and an enlarged detail of the arrangement for connecting the flywheel body to the shaft of the eccentric drive.

FIG. 4 shows a perspective side view of a bushing from the connection arrangement according to FIGS. 2 and 3.

### DETAILED DESCRIPTION

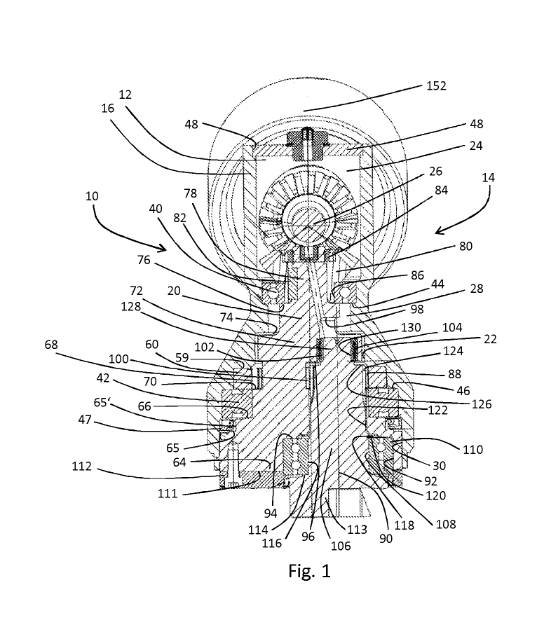

FIGS. 1-3 show an eccentric drive 10 having a gearbox housing 16 surrounding a gearbox chamber 12 of a right-angle gear unit 14. The gearbox housing 16 extends substantially along the axis of rotation 18 of a first shaft 20, the axis of rotation 18 defining a longitudinal direction of the eccentric drive 10. The gearbox chamber 12 is subdivided into a first gearbox chamber 22, which substantially surrounds the first shaft 20, and a second gearbox chamber 24, which substantially surrounds a third shaft 26 arranged at an angle (nearly a right angle) to the longitudinal direction. The gearbox chamber regions 22, 24 are formed adjoining one another in the longitudinal direction and have a common cylindrical transition region 28, which is arranged approximately centrally in relation to the longitudinal extent of the gearbox housing 16 and coaxially with the axis of rotation 18, and by which a connection of the gearbox chamber regions 22, 24 is defined.

In the first gearbox chamber region 22, the gearbox housing 16 has a first cylindrical opening 30, which is oriented coaxially with the axis of rotation 18 and opens the first gearbox chamber region 22 axially outward. The gearbox housing 16 further comprises a second, third and fourth cylindrical opening 32, 34, 36 in the second gearbox chamber region 24. The second opening 32 is oriented coaxially with the axis of rotation 18 and opens the second gearbox chamber 24 axially outward. The third and fourth openings 34, 36 are arranged on both sides of the axis of rotation 18 and coaxially with an axis of rotation 38 of the third shaft 26, which is arranged at an angle (nearly a right angle) to the axis of rotation 18.

A first bearing 40 is arranged in the common transition region 28, and a second bearing 42, for the first shaft 20, is arranged in the first opening 30 in the first gearbox chamber region 22. A shoulder 44, which fixes the bearing 40 axially in the direction of the first opening 30, is formed at the common transition region 28. A shoulder 46 formed at the first opening 30 fixes the bearing 42 in the direction of the common transition region 28. The bearings 40, 42 are preferably constructed as rolling contact bearings and are shown for the sake of example as ball bearings in FIG. 1. The first shaft is received by the bearings 40, 42 and is rotatably mounted in the gearbox housing 16 or in the first gearbox chamber region 22. A first shaft seal ring 47 such as an oil seal, which seals the movement gap between the first opening 30 and the first shaft 20, is also arranged facing outward at the first opening 30, adjacent to the second bearing 42.

In the second gearbox chamber region 24, a housing cover 48, which delimits the second gearbox chamber 24 axially toward the surroundings, is arranged at the second opening 32.

A first bearing 49 in the third opening 34 and a second bearing 50 for the third shaft 26 in the fourth opening 36 are arranged in the second gearbox region 24. A shoulder 52, which fixes the bearing 49 axially in the direction of the fourth opening 36, is formed at the third opening 34. An annular groove 56 provided with a locking ring 54, whereby the bearing 49 is axially fixed in the opposite direction as well, is also formed at the third opening 34. The bearing 50 is arranged floating in the fourth opening 36. The bearings 49, 50 are preferably formed as rolling contact bearings. The third shaft 26 is received by the bearings 49, 50 and is rotatably mounted in the gearbox housing 16 or in the first gearbox chamber region 24. A second shaft seal ring 57, such as an oil seal, which seals the movement gap between the fourth opening 36 and the first shaft 26, is also arranged at the fourth opening 36. A bearing cover 58 provided at the third opening 34 seals the third opening 34 toward the outside.

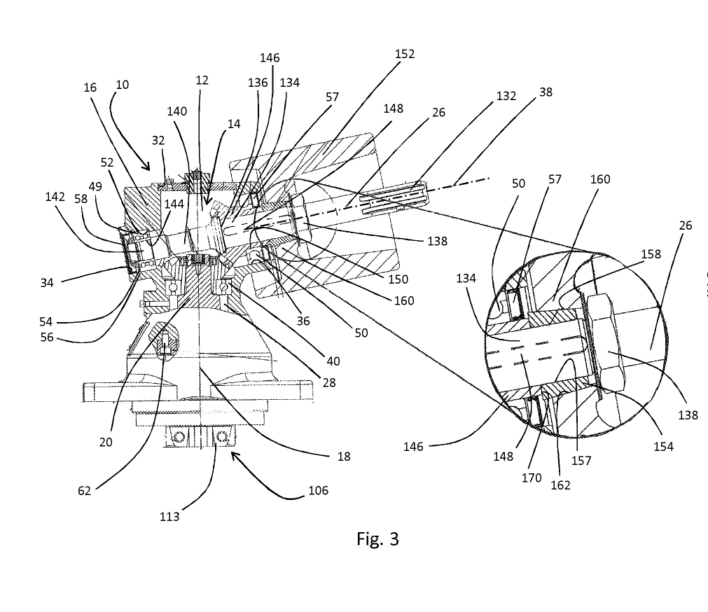

An additional shoulder 59, on which a ring gear 60 is mounted, is also formed in the first gearbox chamber region 22 between the bearings 40, 42. The ring gear 60 is bolted to the gearbox housing 16 by means of bolts 62 distributed on the periphery of the shoulder 59 (see FIG. 3).

The first shaft 20 extends through the entire first gearbox region 22 and has a shaft end region 64, protruding from the first opening 30 and covering substantially the entire diameter of the first opening 30. Starting from the shaft end region 64, a first shaft shoulder 65 is formed, which is adjoined by a shaft seal ring region 65′ for the shaft seal ring 47. Starting from the shaft end region 64, a second shaft shoulder 66 is formed, which is adjoined by a bearing region 68 for the second bearing 42. A third shaft shoulder 70, which is adjoined by a central shaft region 72, is formed adjoining the bearing region 68. The central shaft region 72 ends at a fourth shaft shoulder 74. The fourth shaft shoulder 74 is followed by fifth shaft shoulder 76, which is adjoined by a shaft stub 78, the shaft stub 78 extending through the entire transition region 28 into the second gearbox housing region 24. A first bevel gear 80, which is connected non-rotatably via a key-and-groove connection 82 to the first shaft 20 or the shaft stub 78, is mounted on the shaft stub 78. The shaft stub 78 is provided with a shaft nut 84. A bearing region 86, by which the first shaft 20 is received in the first bearing 40, is formed on the first bevel gear 80.

The first shaft 20 is provided with a cavity 88. The cavity 88 is formed substantially cylindrically about an axis of rotation 90, the axis of rotation 90 being arranged parallel to the axis of rotation 18 and eccentrically to the first shaft 20. The cavity 88 has a cylindrical opening 92, which opens the cavity 88 toward the shaft end 64 of the first shaft 20 axially relative to the axis of rotation 90. Starting from the opening 92, the cavity 88 has a first and a second shoulder 94, 96 and ends at a cavity bottom 98. Between the first and the second shoulders 94, 96, the cavity 88 is provided at the height of the ring gear 60 with an opening 100, which extends radially and axially relative to the axis of rotation 90 along the cavity wall and opens a portion of the cavity wall toward the ring gear 60.

A first bearing seat 102 for receiving a first bearing 104 for a second shaft 106 is formed between the second shoulder 96 of the cavity 88 and the cavity bottom 98. A second bearing seat 108 for receiving a second bearing 110 for the second shaft 106 is formed between the opening 92 of the cavity 88 and the first shoulder 94. The second bearing 110 is axially secured by pressing the outer bearing ring of the second bearing 110 against the first shoulder 94 by means of a plate bolted 112 onto the end face 111 of the shaft end region 64.

The first and second bearings 104, 110 for the second shaft 106 are constructed as rolling contact bearings, wherein a roller bearing in the form of a needle bearing is provided for the first bearing 104 and a ball bearing is provided for the second bearing 110, as illustrated in FIG. 1.

The second shaft 106 extends through the entire cavity 88 of the first shaft 20 and has a shaft end region 113 protruding from first opening 92 of the first shaft 20.

Starting from the shaft end region 113, the second shaft 106 is provided with a first shaft shoulder 114, which is adjoined by a bearing region 116 for the second bearing 110. An annular groove 118 that receives a locking ring 120 (shown in FIG. 1) adjoins the bearing region 116. A second shaft shoulder 122, which ends in a toothed region 124 of the second shaft 106, adjoins the annular groove 118. The toothed region 124 of the second shaft 106 extends axially between the shoulders 94, 96 of the cavity 88 and ends in a third shaft shoulder 126. The third shaft shoulder 126 is adjoined by a shaft stub 128, on which a bearing region 130 for the first bearing 104 is formed.

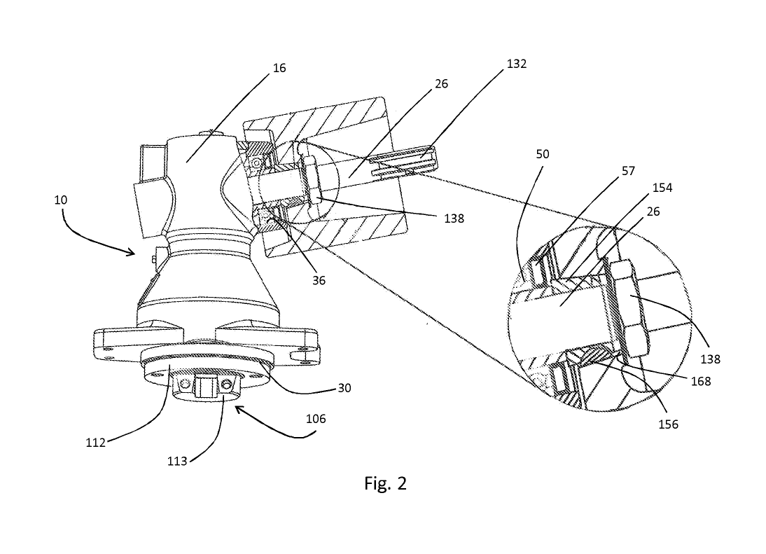

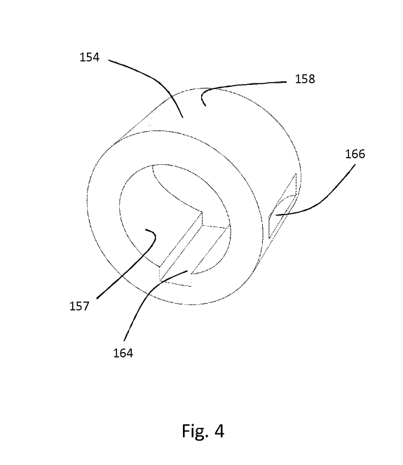

The third shaft 26 extends through the entire second gearbox chamber region 24 and has a toothed shaft end region 132 protruding from the fourth opening 36 (see FIGS. 2 and 3). Starting from the shaft end region 132, the third shaft 26 has a shaft region 134 which is adjoined by a shoulder 136, wherein a part of the shaft region 134, on which a shaft nut 138 is arranged, protrudes from the fourth opening 36. A shaft region 140, adjoined by a shaft stub 142, extends between the shoulder 136 and the third opening 34. A bearing region 144, which is received by the first bearing 49 of the second gearbox chamber region 24, is formed on the shaft stub 142. The bearing region 144 is adjoined by a thread having a shaft nut 145 for axially securing the third shaft 26. A second bevel gear 146, which is connected non-rotatably to the third shaft 26 via a rotational driver 148 in the form of a feather key of a key-and-groove connection, is mounted on the shaft end region 134. A bearing region 150, by which the third shaft 26 is received in the second bearing 50, is formed on the second bevel gear 146. In addition, a flywheel body 152, which is mounted on a bushing 154 and axially secured thereon by means of the shaft nut 138, is arranged on the part of the shaft region 134 protruding from the fourth opening 36. The flywheel body 152 is connected non-rotatably to the third shaft 26 via a further rotational driver 156 in the form of a Woodruff key of a Woodruff key/Woodruff groove connection arranged between bushing 154 and flywheel body 152. As illustrated in FIGS. 2, 3 and 4, the bushing 154 has a cylindrically shaped inner surface 157 and an outer surface 158 that tapers conically in the direction of the shaft end region 132. The flywheel body 152 has a hub 160 with a conically tapering inner surface 162 matching the outer surface 158 of the bushing 154. In addition, a key groove 164, which is engaged with the rotational driver 148 constructed as a key, is formed on the inner surface 157 of the bushing 154. A recess 166 in the form of a Woodruff key groove, which engages with the rotational driver 156 constructed as a Woodruff key, is also formed on the outer surface 158 of the bushing 154, wherein a groove 168 engaging with the rotational driver 156 is formed in the hub 160, so that a rotatably fixed connection between bushing 154 and hub 160 is produced via the rotational driver 156.

The assembly and the relevant advantages of the illustrated eccentric drive 10 will now be briefly discussed.

Starting from the gearbox housing 16, the housing is equipped with the ring gear 60 and with the second bearing 42 for the first shaft 20, as well as with the first shaft seal ring 47. This is followed by the insertion of the first shaft 20 into the first gearbox chamber region 22 through the first opening 30. The first bevel gear 80, preassembled with the second bearing 40, is guided via the shaft stub 78 through the second opening 32 of the second gearbox region 24. The bevel gear 80 and the bearing 40 are axially clamped by the shaft nut 84 and the shaft shoulder 76, and the first shaft 20 is axially secured.

The second shaft 106 is preassembled with the first bearing 104 and the second bearing 110, the second bearing 110 being secured with the locking ring 120 in the annular groove 118. The preassembled second shaft 106 is guided into the cavity 88 of the first shaft 20 and axially fixed by means of the plate 112.

The third shaft 26 is preassembled in such a way that the shaft region 134 is preassembled with the second bevel gear 146 and the second bearing 50. The opening 34 is equipped with the first bearing 49. The third shaft 26, together with bevel gear 146 and second bearing 50, can then be guided with the shaft stub 144 at the front through the first opening 36 into the second gearbox chamber region 24, and can be pushed into the first bearing 49 and secured via the shaft nut 145 on the first bearing 49, already fixed in the first opening 34.

After insertion of the third shaft 26, the shaft is sealed by the shaft seal ring 57, which is fitted between second bevel gear 146 and second opening 36. This is followed by the mounting of the flywheel body 152. The bushing 154 is first pushed onto the shaft region 134, with the key groove 164 oriented flush with the rotational driver 148 (feather key). Then the rotational driver 156 (Woodruff key) is placed in the recess 166 formed as a Woodruff key groove, before the flywheel body 152, along with its hub 160 and the groove 168 formed therein, is pushed, aligned with the rotational driver 148 (Woodruff key), onto the outer surface 158 of the bushing 154. The conically formed outer surface 158 of the bushing and the conically formed inner surface 162 of the hub 160 are then pushed or pressed onto one another or clamped to one another by screwing the shaft nut 138 onto the shaft region 134. The flywheel body 152 is thus clamped, together with the bushing 154, between one end of the second bevel gear 146, which forms a shoulder 170, and the shaft nut 138.

The conical formations of the hub 162 and the bushing 154 achieve, with a relatively low axial clamping force, both a high level of axial clamping between second bevel gear 146 and shaft nut 138 and a fixation of the flywheel body in the circumferential direction of the second shaft 26 with a high-level of frictional engagement in the circumferential direction between bushing 154 and flywheel body 152. A detachment of the flywheel body even under the highest stresses during operation is prevented by the increased frictional engagement between bushing 154 and flywheel body 152, and by the high level of axial clamping. Due to the increased frictional engagement between the bushing 154 and the flywheel body 152 and the high level of axial clamping of both parts of the bushing to the flywheel body, loosening even under extreme stress during operation can be prevented. The high level of frictional engagement between bushing 154 and flywheel body 152, which is created by the conical arrangement, makes it possible for a Woodruff key with a Woodruff key-woodruff key groove connection to suffice as the rotational driver 156, which requires a substantially lower production expense compared to a conventional key-and-groove connection. Nevertheless, a key-and-groove connection can alternatively be used here.

Even though the invention was described with reference to only one embodiment, various alternatives, modifications and variants that fall under the present invention will be evident to a person skilled in the art in light of the foregoing description.

1. An eccentric drive (10) for driving cutter mechanisms on mowing attachments for combine harvesters, comprising: a gearbox housing (16); a gearbox chamber (12) enclosed by the gearbox housing (16); a first shaft (20) mounted in the gearbox housing (16); a cavity (88) formed in the first shaft (20) and having its cross-sectional center of gravity eccentric to an axis of rotation (18), in which cavity a second shaft (106) is rotatably mounted, having a toothed region (124), which is engaged with the gearbox housing (16), and a shaft end region (113) protruding axially from the cavity (88) of the first shaft (20); and a third shaft (26) mounted in the gearbox housing (16), the axis of rotation (38) of which third shaft includes an angle to a plane lying on the axis of rotation (18) of the first shaft (20), wherein the third shaft (26) accommodates a flywheel body (152), wherein the flywheel body (152) can be connected to the third shaft (26) via a bushing (154) that is tapered on its outer surface (158) and is arranged rotatably fixedly and axially fixably on the third shaft (26), wherein the flywheel body (152) has a conically tapering hub (160) corresponding to the outer surface (158) of the bushing (154), with which hub the flywheel body (152) can be pressed against the outer surface (158) of the bushing (154) by means of a shaft nut (138) arranged on the third shaft (26).

2. The eccentric drive (10) according to claim 1, wherein a recess (166) for receiving a rotational driver (156) is formed on the outer surface (158) of the bushing (154), and a broached groove (168) is formed on the inner side (162) of the hub (160).

3. The eccentric drive (10) according to claim 2, wherein the recess (166) on the bushing (154) is formed as a Woodruff key groove and the rotational driver (156) as a Woodruff key.

4. The eccentric drive (10) according to claim 2, wherein the recess (166) on the bushing (154) is formed as a feather key groove and the rotational driver (156) as a feather key.

5. The eccentric drive (10) according to claim 1, wherein a recess for receiving a rotational driver (148) is formed on the third shaft (26) and a broached groove (164) is formed on the inner side (157) of the bushing (154).

6. The eccentric drive (10) according to claim 5, wherein the recess on the third shaft (26) is formed as a feather key groove and the rotational driver (148) as a feather key.
